(19) United States
(12) Patent Application Publication
(10) Pub. No.: US 2016/0371024 A1
(43) Pub. Date: Dec. 22, 2016

(54) MEMORY SYSTEM AND OPERATING METHOD THEREOF

(71) Applicants: SHINSUNG International Patent & Law Firm, Seoul (KR); SK hynix Inc., Gyeonggi-do (KR)

(72) Inventors: Sang-Jun PARK, Gyeonggi-do (KR); Do-Young JOO, Gyeonggi-do (KR); Jong-Bae JEONG, Seoul (KR)

(21) Appl. No.: 14/957,348

(22) Filed: Dec. 2, 2015

(30) Foreign Application Priority Data
Jun. 17, 2015 (KR) 10-2015-0085785

(51) Int. Cl. G06F 3/06

(52) U.S. Cl. CPC G06F 3/0619; G06F 3/065; G06F 3/0659; G06F 3/0685

(57) ABSTRACT

A memory system includes a memory device including a plurality of memory blocks; and a controller suitable for performing read and write operations respectively in response to read and write commands, and update map data, which is stored in a buffer, as a result of the operations according to priority information of data stored in the memory blocks.

### CROSS-REFERENCE TO RELATED APPLICATION

This application claims priority under 35 U.S.C. §119 to Korean Patent Application No. 10-2015-0085785 filed on Jun. 17, 2015 in the Korean Intellectual Property Office, the disclosure of which is incorporated herein by reference in its entirety.

### TECHNICAL FIELD

Exemplary embodiments relate to a memory system, and more particularly, to a memory system which processes data to and from a memory device, and an operating method thereof.

### DISCUSSION OF THE RELATED ART

The computer environment paradigm has shifted to ubiquitous computing systems that can be used anytime and anywhere. As a result use of portable electronic devices such as mobile phones, digital cameras, and notebook computers continues to increase rapidly. Portable electronic devices generally use a memory system having a semiconductor memory device used as a data storage device. The data storage devices are used as main or auxiliary memory devices of a portable electronic device.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

### SUMMARY

Various embodiments are directed to a memory system capable of minimizing its complexity and performance deterioration, and an operating method thereof.

In an embodiment, a memory system may include a memory device including a plurality of memory blocks; and a controller suitable for performing read and write operations respectively in response to read and write commands, and update map data, which is stored in a buffer, as a result of the operations according to priority information of data stored in the memory blocks.

The priority information may be included in each of the commands.

The priority information may represent priorities between first and second data corresponding to the command provided at different times.

The priorities between the first data and the second data may be determined according to data importance or data processability between the first data and the second data. The data importance may be determined according to kinds of the first data and the second data. The data processability may be determined according to processing counts, required processing speeds and data sizes of the first data and the second data.

In the case where the buffer is full of the map data, the controller may program one of the map data having a lowest priority into the memory blocks according to the priority information.

In the case where two or more of the map data have the same lowest priority, the controller may program one of the two or more map data having a lowest update priority into the memory blocks according to update priorities of the map data.

The lowest update priority may be determined according to an LRU (least recently used)/MRU (most recently used) algorithm.

The controller may store the map data in different sub buffers in the buffer according to type information of the data. The type information may be determined according to locality of the data and a frequency/count of the operations.

The type information of the data may be included in each of the commands, or identified from a pattern of each of the commands.

The controller may store map data for random data or hot data in a first sub buffer, and store map data for consecutive data or cold data in a second sub buffer according to the type information.

In an embodiment, a method for operating a memory system including a plurality of memory blocks may include identifying a command provided from a host; performing an operation in response to the command; and updating map data, which is stored in a buffer, as a result of the operation according to priority information of data stored in the memory blocks.

The priority information may be included in the command.

The priority information may represent priorities between first and second data corresponding to a command provided at different time.

The priorities between the first data and the second data may be determined according to data importance or data processability between the first data and the second data, the data importance may be determined according to kinds of the first data and the second data, and the data processability may be determined according to processing counts or required processing speeds of the first data and the second data.

In the case where the buffer is full of the map data, the updating of the map data may program one of the map data having a lowest priority into the memory blocks according to the priority information.

In the case where two or more of the map data have the same lowest priority, the updating of the map data may program one of the two or more map data having a lowest update priority into the memory blocks according to update priorities of the map dat.

The lowest update priority may be determined according to an LRU (least recently used)/MRU (most recently used) algorithm.

In the updating, the map data may be stored in different sub buffers in the buffer according to type information of the data, and the type information may be determined according to locality of the data and a frequency/count of the operation.

The type information of the data may be included in the command, or identified from a pattern of the command.

In the updating, map data for random data or hot data may be stored in a first sub buffer and map data for consecutive data or cold data may be stored in a second sub buffer, according to the type information.

### BRIEF DESCRIPTION OF THE DRAWINGS

FIG. 1 is a diagram illustrating a data processing system including a memory system in accordance with an embodiment.

FIG. 2 is a diagram illustrating a memory device in a memory system.

FIG. 3 is a circuit diagram illustrating a memory block in a memory device in accordance with an embodiment.

FIGS. 4, 5, 6, 7, 8, 9, 10 and 11 are diagrams schematically illustrating a memory device.

FIG. 12 is a schematic diagram illustrating a data processing operation of a memory device in a memory system in accordance with an embodiment.

FIG. 13 is a flow chart illustrating the data processing operation of a memory system in accordance with an embodiment.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

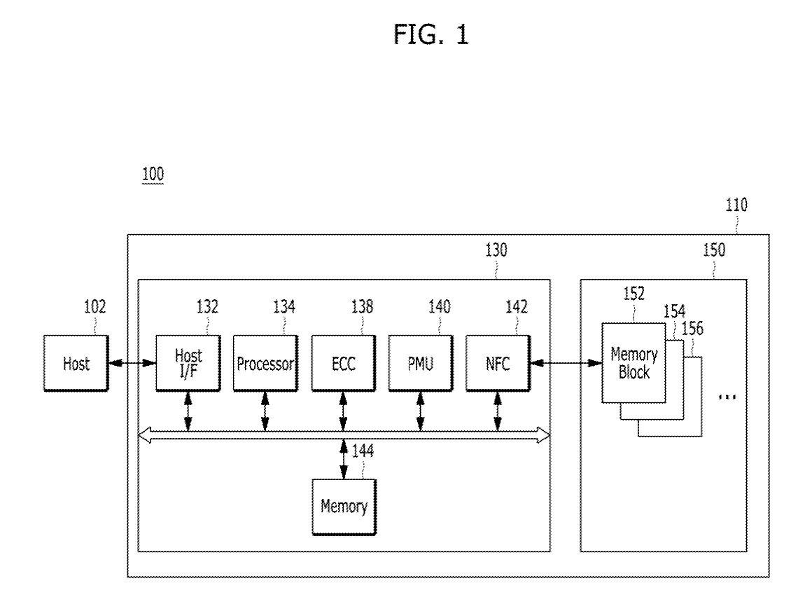

FIG. 1 is a block diagram illustrating a data processing system including a memory system in accordance with an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with various kinds of storage devices such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

Furthermore, the memory system 110 may configure a computer, an ultra-mobile PC (UMPC) a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an REID device, and/or one of various component elements configuring a computing system.

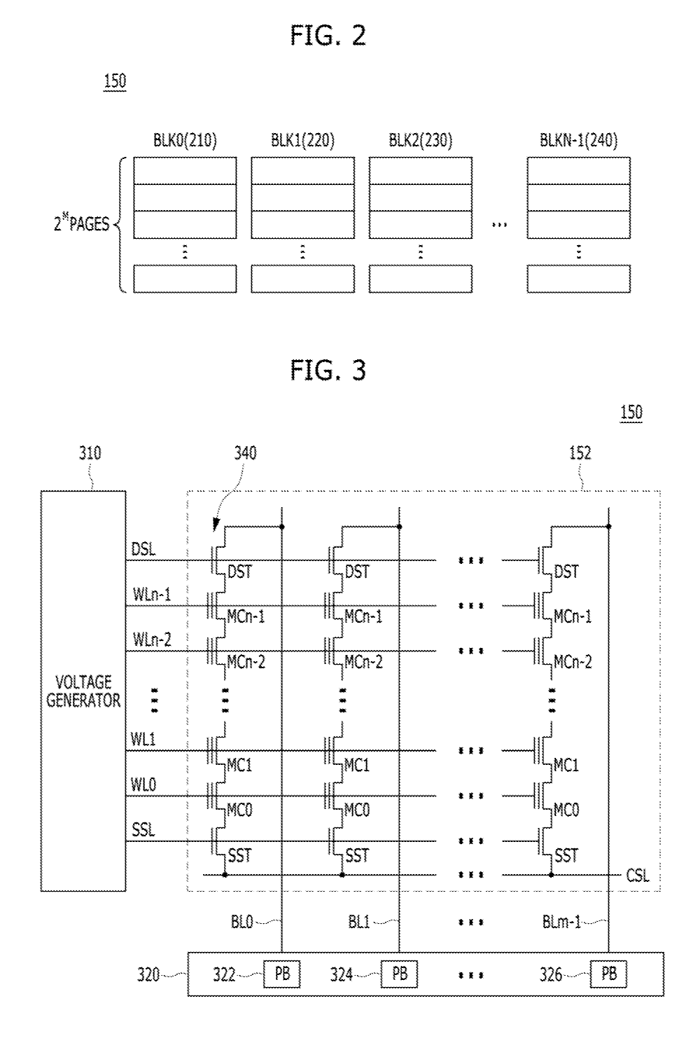

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. As such, the controller 130 may control overall operations of the memory device 150 such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and the ECC unit 138 may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130 (e.g., power for the component elements included in the controller 130).

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, as well as a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory (e.g., a NAND flash memory), a program failure may occur during the write operation (e.g., during the program operation), due to characteristics of a NAND logic function. During the bad block management, the data of the program-failed memory block or the bad memory block may be programmed into a new memory block. Also, the bad blocks seriously deteriorate the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2, the memory device 150 may include a plurality of memory blocks (e.g., zeroth to (N−1)^{th} blocks 210 to 240). Each of the plurality of memory blocks 210 to 240 may include a plurality of pages (e.g., 2^{M} number of pages (2^{M} PAGES)), to which the present invention is not limited. Each of the plurality of pages may include a plurality of memory cells to which a plurality of word lines are electrically coupled.

The memory device 150 also may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data (e.g., two or more-bit data). An MLC memory block including a plurality of pages which are implemented with memory cells that are each capable of storing 3-bit data may be defined as a triple level cell (TLC) memory block.

Each memory block 210 to 240 may store the data provided from the host device 102 during a write operation and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 are electrically coupled in series between the select transistors DST and SST. The respective memory cells MC0 to MCn−1 are configured by multi-level cells (MLC) each of which stores data information of a plurality of bits. The strings 340 are electrically coupled to the corresponding bit lines BL0 to BLm−1, respectively. For reference, in FIG. 3, ‘DL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 in accordance with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages (e.g., a program voltage, a read voltage and/or a pass voltage) to be supplied to respective word lines according to an operation mode and provide voltages to be supplied to bulks (e.g., well regions in which the memory cells are formed). The voltage supply block 310 may perform a voltage generating operation under the control of a control circuit (not shown). The voltage supply block 310 generates a plurality of variable read voltages to generate a plurality of read data, selects one of the memory blocks or sectors of a memory cell array under the control of the control circuit, selects one of the word lines of the selected memory block, and provides the word line voltages to the selected word line and unselected word lines.

A read/write circuit 320 of the memory device 150 is controlled by the control circuit, and serves as a sense amplifier or a write driver according to an operation mode. During a verification/normal read operation, the read/write circuit 320 serves as a sense amplifier for reading data from the memory cell array. Also, during a program operation, the read/write circuit 320 serves as a write driver that drives bit lines according to data to be stored in the memory cell array. The read/write circuit 320 receives data to be written in the memory cell array from a buffer (not shown) during the program operation, and drives the bit lines according to the inputted data. The read/write circuit 320 includes a plurality of page buffers 322, 324 and 326 respectively corresponding to columns (or bit lines) or pairs of columns (or pairs of bit lines). A plurality of latches (not shown) may be included in each of the page buffers 322, 324 and 326.

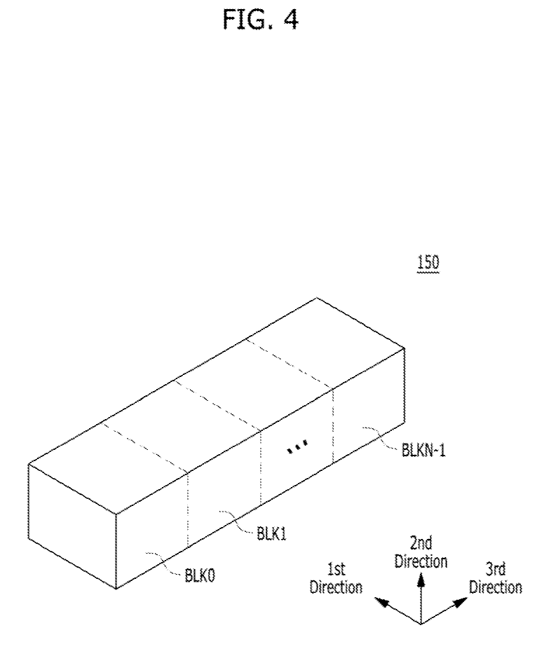

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN−1, and each of the memory blocks BLK0 to BLKN−1 may be realized in a three-dimensional (3D) structure or a vertical structure. The respective memory blocks BLK0 to BLKN−1 may include structures which extend in first to third directions (e.g., an x-axis direction, a y-axis direction and a z-axis direction).

The respective memory blocks BLK0 to BLKN−1 may include a plurality of NAND strings NS which extend in the second direction. The plurality of NAND strings NS may be provided in the first direction and the third direction. Each NAND string NS is electrically coupled to a bit line BL, at least one source select line SSL, at least one ground select line GSL, a plurality of word lines WL, at least one dummy word line DWL, and a common source line CSL. Namely, the respective memory blocks BLK0 to BLKN−1 are electrically coupled to a plurality of bit lines BL, a plurality of source select lines SSL, a plurality of ground select lines GSL, a plurality of word lines WL, a plurality of dummy word lines OWL, and a plurality of common source lines CSL.

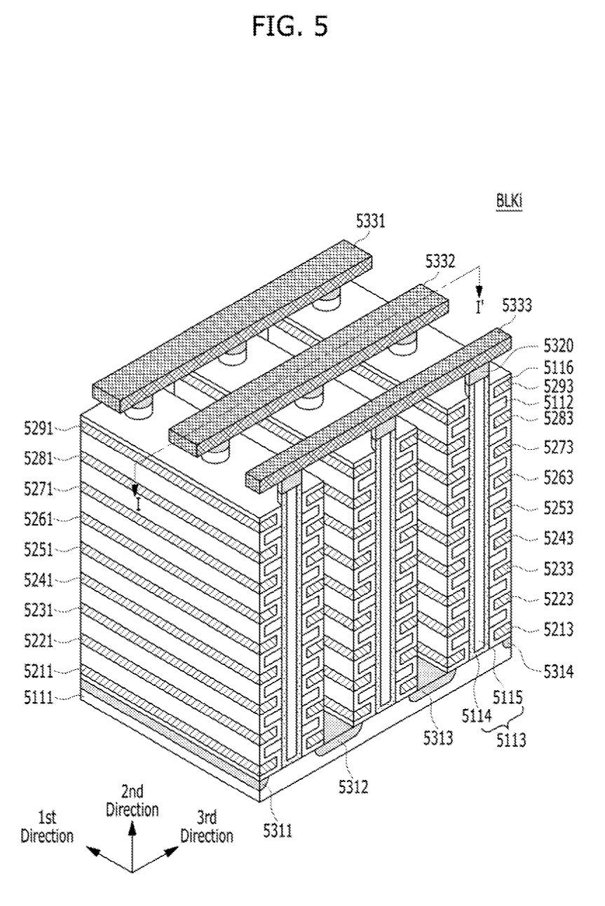

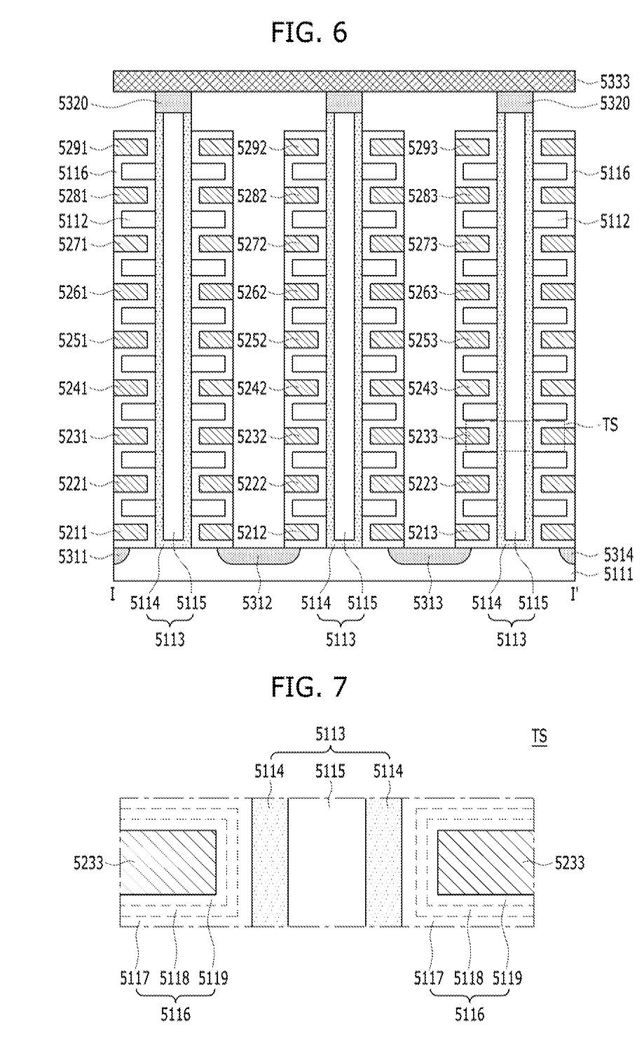

FIG. 5 is a isometric view of one BLKi of the plural memory blocks BLK0 to BLKN−1 shown in FIG. 4. FIG. 6 is a cross-sectional view taken along a line of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well (e.g., a pocket p-well) and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material. 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (I) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313 the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as the structures between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed that the drains 5320 include n-type silicon, it is to be noted that the drains 5320 are not limited to being n-type silicon. For example, the width of each drain 5320 may be greater than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer (e.g., an aluminum oxide layer, a hafnium oxide layer, etc.) that has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111 (e.g., the second direction) and may serve as a NAND flash memory block (e.g. of a charge capturing type memory) to which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the First direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

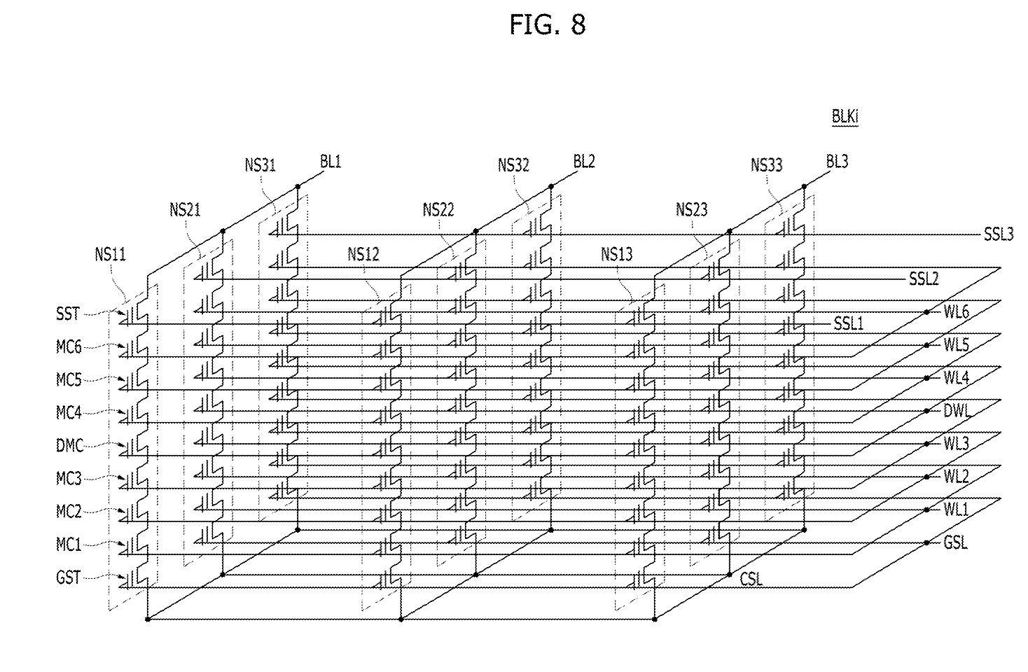

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS are defined by units of rows and columns and NAND strings NS which are electrically coupled to one bit line may form one column. The NAND strings NS11 to NS31 which are electrically coupled to the first bit line BL1 correspond to a first column, the NAND strings NS12 to NS32 which are electrically coupled to the second bit line BL2 correspond to a second column, and the NAND strings NS13 to NS33 which are electrically coupled to the third bit line BL3 correspond to a third column. NAND strings NS which are electrically coupled to one source select line SSL form one row. The NAND strings NS11 to NS13 which are electrically coupled to a first source select line SSL1 form a first row, the NAND strings NS21 to NS23 which are electrically coupled to a second source select line SSL2 form a second row, and the NAND strings NS31 to NS33 which are electrically coupled to a third source select line SSL3 form a third row.

In each NAND string NS, a height is defined. In each NAND string NS, the height of a memory cell MC1 adjacent to the ground select transistor GST has a value ‘1’. In each NAND string NS, the height of a memory cell increases as the memory cell gets closer to the source select transistor SST when measured from the substrate 5111. In each NAND string NS, the height of a memory cell MC6 adjacent to the source select transistor SST is 7.

The source select transistors SST of the NAND strings NS in the same row share the source select line SSL. The source select transistors SST of the NAND strings NS in different rows are respectively electrically coupled to the different source select lines SSL1, SSL2 and SSL3.

The memory cells at the same height in the NAND strings NS in the same row share a word line WL. That is, at the same height, the word lines WL electrically coupled to the memory cells MC of the NAND strings NS in different rows are electrically coupled. Dummy memory cells DMC at the same height in the NAND strings NS of the same row share a dummy word line DWL. Namely, at the same height or level, the dummy word lines DWL electrically coupled to the dummy memory cells DMC of the NAND strings NS in different rows are electrically coupled.

The word lines WL or the dummy word lines DWL located at the same level or height or layer are electrically coupled with one another at layers where the conductive materials 5211 to 5291, 5212 to 5292 and 5213 to 5293 which extend in the first direction are provided. The conductive materials 5211 to 5291, 5212 to 5292 and 5213 to 5293 which extend in the first direction are electrically coupled in common to upper layers through contacts. At the upper layers, the conductive materials 5211 to 5291, 5212 to 5292 and 5213 to 5293 which extend in the first direction are electrically coupled. In other words, the ground select transistors GST of the NAND strings NS in the same row share the ground select line GSL. Further, the ground select transistors GST of the NAND strings NS in different rows share the ground select line GSL. That is, the NAND strings NS11 to NS13, NS21 to NS23 and NS31 to NS33 are electrically coupled to the ground select line GSL.

The common source line CSL is electrically coupled to the NAND strings NS. Over the active regions and over the substrate 5111, the first to fourth doping regions 5311 to 5314 are electrically coupled. The first to fourth doping regions 5311 to 5314 are electrically coupled to an upper layer through contacts and, at the upper layer, the first to fourth doping regions 5311 to 5314 are electrically coupled.

As shown in FIG. 8, the word lines WL of the s me height or level are electrically coupled. Accordingly, when a word line WL at a specific height is selected, all NAND strings NS which are electrically coupled to the word line WL are selected. The NAND strings NS in different rows are electrically coupled to different source select lines SSL. Accordingly, among the NAND strings NS electrically coupled to the same word line WL, by selecting one of the source select lines SSL1 to SSL3, the NAND strings NS in the unselected rows are electrically isolated from the bit lines BL1 to BL3. In other words, by selecting one of the source select lines SSL1 to SSL3, a row of NAND strings NS is selected. Moreover, by selecting one of the bit lines BL1 to BL3, the NAND strings NS in the selected rows are selected in units of columns.

In each NAND string NS, a dummy memory cell DMC is provided. In FIG. 8 the dummy memory cell DMC is provided between a third memory cell MC3 and a fourth memory cell MC4 in each NAND string NS. That is, first to third memory cells MC1 to MC3 are provided between the dummy memory cell DMC and the ground select transistor GST. Fourth to sixth memory cells MC4 to MC6 are provided between the dummy memory cell DMC and the source select transistor SST. The memory cells MC of each NAND string NS are divided into memory cell groups by the dummy memory cell DMC. In the divided memory cell groups, memory cells (e.g., MC1 to MC3) adjacent to the ground select transistor GST may be referred to as a lower memory cell group, and memory cells, for example, MC4 to MC6, adjacent to the string select transistor SST may be referred to as an upper memory cell group.

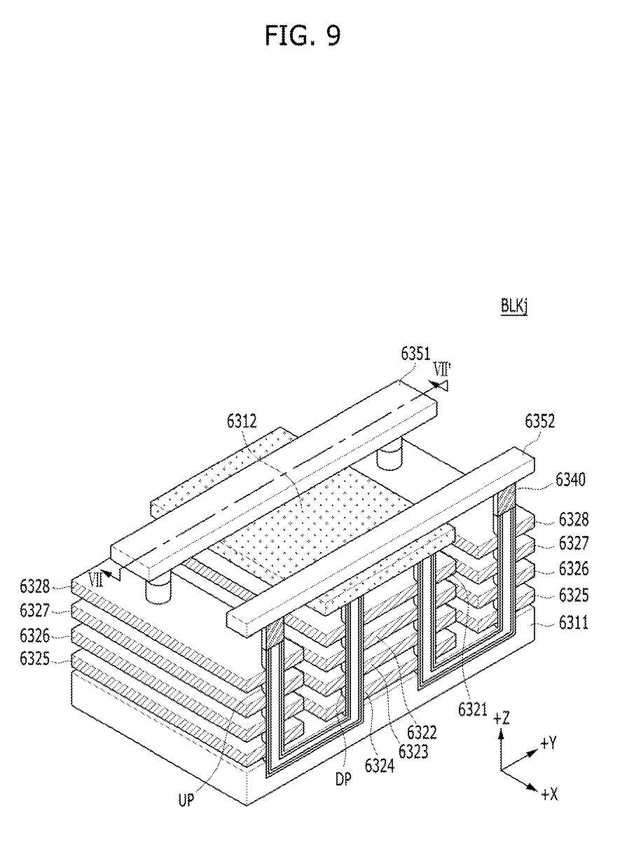

Herein, detailed descriptions will be made with reference to FIGS. 9 to 11, which show the memory device in the memory system in accordance with an embodiment implemented with a three-dimensional (3D) nonvolatile memory device different from the first structure.

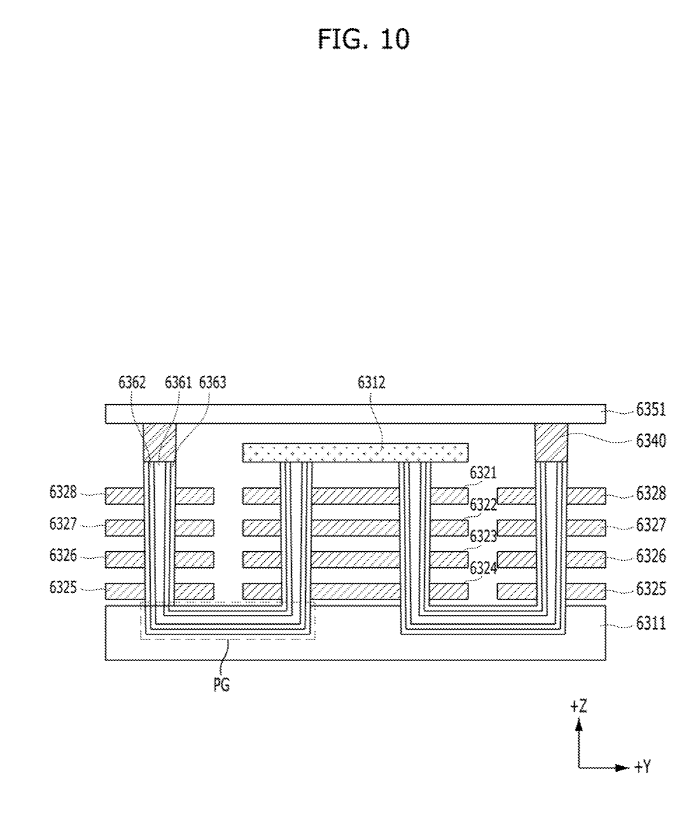

FIG. 9 is an isometric view schematically illustrating the memory device implemented with the three-dimensional (3D) nonvolatile memory device and showing a memory block BLKj of the plurality of memory blocks of FIG. 4. FIG. 10 is a cross-sectional view illustrating the memory block BLKj taken along the line VII-VII′ of FIG.

Referring to FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well (e.g., a pocket p-well) and include an n-type well which surrounds the p-type well. While it is assumed in the embodiment that the substrate 6311 is p-type silicon, it is to be noted that the substrate 6311 is not limited to being p-type silicon.

First to fourth conductive materials 6321 to 6324 which extend in the x-axis direction and the y-axis direction may be provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

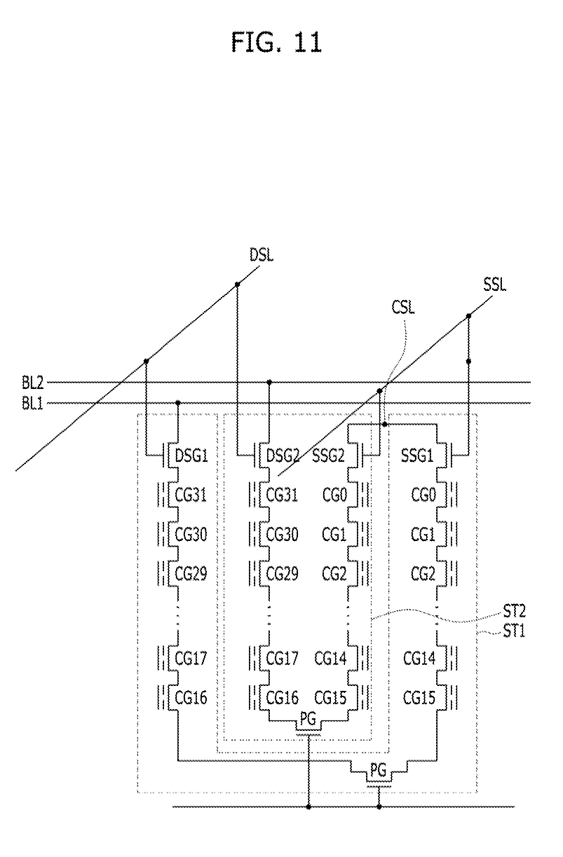

FIG. 11 is a circuit diagram illustrating the equivalent circuit of the memory block BLKj having the second structure as described above with reference to FIGS. 9 and 10. A first string and a second string, which form a pair in the memory block BLKj in the second structure are shown.

Referring to FIG. 11, in the memory block BLKj having the second structure among the plurality of blocks of the memory device 150 cell strings, each of which is implemented with one upper string and one lower string electrically coupled through the pipe gate PG as described above with reference to FIGS. 9 and 10, is provided in such a way as to define a plurality of pairs.

In the certain memory block BLKj having the second structure, memory cells CG0 to CG31 stacked along a first channel CH1 (not shown) (e.g., at least one source select gate SSG1 and at least one drain select gate DSG1) form a first string ST1, and memory cells CG0 to CG31 stacked along a second channel CH2 (not shown) to (e.g., at least one source select gate SSG2 and at least one drain select gate DSG2) form a second string ST2.

The first string ST1 and the second string ST2 are electrically coupled to the same drain select line DSL and the same source select line SSL. The first string ST1 is electrically coupled to a first bit line BL1, and the second string ST2 is electrically coupled to a second bit line BL2.

While it is described in FIG. 11 that the first string ST1 and the second string ST2 are electrically coupled to the same drain select line DSL and the same source select line SSL, it is contemplated that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it is contemplated that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

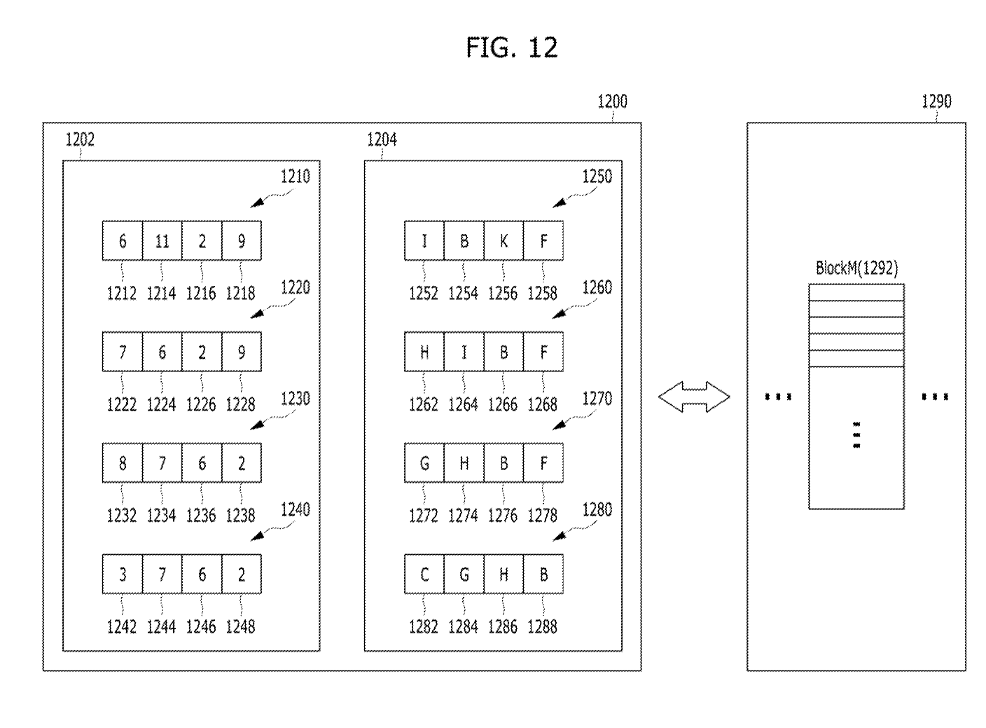

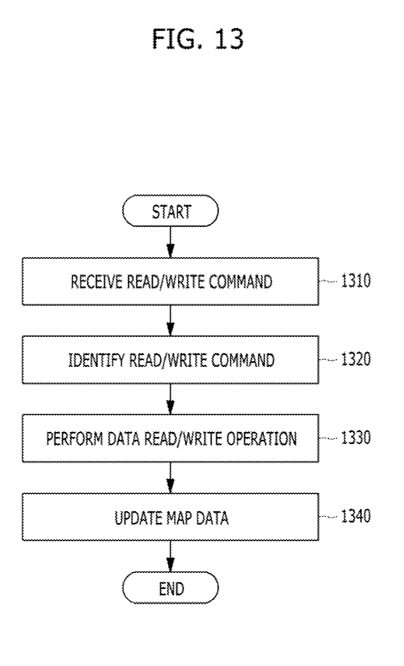

Detailed descriptions will be made with reference to FIGS. 12 and 13, for data processing operation of the memory device 150, particularly, a map data update operation during reading/writing operation of the memory device 150 in the memory system 110 in accordance with an embodiment.

FIG. 12 is a schematic diagram illustrating a data processing operation of the memory device 150 in memory system 110 in accordance with an embodiment.

Descriptions will be made, as an example, for processing of map data corresponding to the read data/write data when read data or write data are stored in the buffer/cache included in the memory 144 of the controller 130, and then the data stored in the buffer/cache are read/written from to the plurality of memory blocks included in the memory device 150.

The map data may include map information of read/write data stored in the memory device 150, address information, page information, logical to physical (L2P) information and physical to logical (P2L) information. The map data may be metadata including such map information.

Further, while it will be described below as an example for the sake of convenience in explanation that the controller 130 performs the data processing operation in the memory system 110, it is to be noted that, as described above, the processor 134 included in the controller 130 may perform data processing.

In the embodiment which will be described below, descriptions will be made for the map data update operation of the controller 130 to update the map data after the program operation or the read operation. During the program operation, the controller 130 to stores the write data, which is provided from the host 102, in the buffer/cache included in the memory 144 of the controller 130 and then the data stored in the buffer/cache are programmed to the plurality of memory blocks included in the memory device 150. During the read operation, the controller 130 reads read data corresponding to the read command from a corresponding block of the memory device 150 and then stores the read data in the buffer/cache included in the memory 144 of the controller 130. Then, the data stored in the buffer/cache are provided to the host 102.

Referring to FIG. 12, the controller 130 performs the write or read operation and updates the map data of write data and read data corresponding to the write operation and the read operation.

For example, the controller 130 updates map data (hereinafter, referred to as ‘map data 2’) in the case of reading/writing data of a logical page number 2 (hereinafter, referred to as ‘data 2’), map data (hereinafter, referred to as ‘map data 3’) in the case of reading/writing data of a logical page number 3 (hereinafter, referred to as data 3′), map data (hereinafter, referred to as ‘map data 6’) in the case of reading/writing data of a logical page number 6 (hereinafter, referred to as ‘data 6’), map data (hereinafter, referred to as ‘map data 7’) in the case of reading/writing data of a logical page number 7 (hereinafter, referred to as ‘data 7’), map data (hereinafter, referred to as nap data 8′) n the case of reading/writing data of a logical page number 8 (hereinafter, referred to as ‘data 8’), map data (hereinafter, referred to as ‘map data 9’) in the case of reading/writing data of a logical page number 9 (hereinafter, referred to as ‘data 9’), and map data (hereinafter, referred to as ‘map data 11’) in the case of reading/writing data of a logical page number 11 (hereinafter, referred to as ‘data 11’).

The data of the logical page numbers (e.g., the data 2, the data 3 the data 6, the data 7 the data 8 the data 9 and the data 11) are random data according to the locality of data or hot data according to the frequency/count of the read/write operation. The locality of data and the frequency/count of the read/write operation are checked through the pattern of a read/write command, and the controller 130 identifies data corresponding to the read/write command provided from the host 102 as the random data or the hot data by checking the pattern of the read/write command.

Also, the controller 130 updates map data (hereinafter, referred to as ‘map data B’) in the case of reading/writing data of a logical page number group B (hereinafter, referred to as ‘data B’), map data (hereinafter, referred to as ‘map data C’) in the case of reading/writing data of a logical page number group C (hereinafter, referred to as ‘data C’), map data (hereinafter, referred to as ‘map data F’) in the case of reading/writing data of a logical page number group F (hereinafter, referred to as ‘data F’), map data (hereinafter, referred to as ‘map data G’) in the case of reading/writing data of a logical page number group G (hereinafter, referred to as ‘data G’), map data (hereinafter, referred to as ‘map data H’) in the case of reading/writing data of a logical page number group H (hereinafter, referred to as ‘data H’), map data (hereinafter, referred to as ‘map data I’) in the case of reading/writing data of a logical page number group I (hereinafter, referred to as ‘data I’), and map data (hereinafter, referred to as ‘map data K’) in the case of reading/writing data of a logical page number group K (hereinafter, referred to as ‘data K’).

The data of the logical page number groups (e.g., the data B, the data C, the data F, the data G, the data H, the data I and the data K) are data in which a plurality of logical page numbers are consecutive according to the locality of data, or cold data according to the frequency/count of read/write operation. As described above, the locality of data and the frequency/count of the read/write operation are checked through the pattern of a read/write command, and the controller 130 identifies data corresponding to the read/write command provided from the host 102 as consecutive data or cold data by checking the pattern of the read/write command.

Thus, the controller 130 determines whether the read/write data are random data/consecutive data or hot data/cold data based on the read/write command provided from the host 102. The type information indicating whether read/write data are random to data/consecutive data or hot data/cold data may be included in the read/write command in the form of a context, and the controller 130 identifies the type information of the read/write data by checking the information included in the read/write command or by checking locality and frequency/count of the read/write operation from the pattern of the read/write command as described above.

The controller 130 checks the priority information of the read/write data from the read/write command. The priority information is included in the read/write command in the form of a context or in the form of a flag. The priority information included in the read/write command indicates whether the current read/write data has a higher priority or a lower priority than the previous read/write data. For example, in the case where the current read/write data has a higher priority than the previous read/write data, the priority value ‘1’ of the read/write data may be included in the read/write command. In the case where the current read/write data has a lower priority than the previous read/write data, the priority value ‘0’ of the read/write data may be included in the read/write command.

The priority of read/write data is determined by data importance according to the kind of the read/write data and data processability according to a processing for update) count of the read/write data, a required processing speed or a data size. For example, in the case where a first read/write data has higher data importance or data processability than a second read/write data, the first read/write data has a higher priority than the second read/write data. The read/write operation for the first read/write data of the higher priority may be performed prior to the second read/write data. The priority of read/write data is determined by the host 102 according to data importance or data processability, and the priority information is transferred to the controller 130 through the read/write command.

The controller 130 performs the read/write operation for the read/write data in response to the read/write command including the type information and the priority information of the read/write data from the host 102. The controller 130 also performs the map data update operation for updating map data to reflect a result of the read/write operation in to the map dat.

After performing a read/write operation for read/write data according to the read/write command provided from the host 102 at a specified time t0 1210 and 1250, the controller 130 performs the map data update operation for the read/write data according to the read/write operation and stores the updated map data in a buffer 1200 included in the memory 144 of the controller 130. In the case where the buffer 1200 is full of the map data, the controller 130 writes the map data in a memory block M 1292 among plural memory blocks of the memory device 150.

The controller 130 stores the updated map data in different buffer regions of the buffer 1200 according to the type information of the read/write data (e.g., a first sub buffer 1202 and a second sub buffer 1204). It will be further described as an example that map data for the random data or the hot data are stored in the first sub buffer 1202 and map data for the consecutive data or the cold data are stored in the second sub buffer 1204.

For example, according to the read/write command provided from the host 102 at the time t0 1210 and 1250, map data 6 1212, map data 11 1214, map data 2 1216 and map data 9 1218 are stored in the first sub buffer 1202 as map data corresponding to the command at the time t0 1210, and map data I 1252, map data B 1254, map data K 1256 and map data F 1258 are stored in the second sub buffer 1204 as map data corresponding to the command at the time t0 1250.

The map data stored in the first sub buffer 1202 and the second sub buffer 1204 have priorities according to the priority information of the read/write data included in the read/write command. For example, among the map data stored in the first sub buffer 1202 of the time t0 1210, the map data 2 1216 may have the highest priority, the map data 11 1214 may have the lowest priority, and the map data 6 1212 may have a higher priority than the map data 9 1218. Also, among the map data stored in the second sub buffer 1204 at the time t0 1250, the map data B 1254 may have the highest priority, the map data K 1256 may have the lowest priority, and the map data F 1258 may have a higher priority than the map data I 1252.

According to the read/write commands provided from the host 102 at the time t0 1210 and 1250 and times previous to the time t0, the read/write operation is performed for the read/write data. Since map data for the read/write data are updated in correspondence to the read/write operation performed in this way, the map data stored in the first sub buffer 1202 and the second sub buffer 1204 have update priorities according to the update times.

For example, among the map data stored in the first sub buffer 1202 at the time t0 1210, the map data 6 1212 most recently updated may have the highest update priority, the map data 9 1218 least recently updated may have the lowest update priority, and the map data 11 1214 may have a higher update priority than the map data 2 1216. Also, among the map data stored in the second sub buffer 1204 at the time t0 1250, the map data I 1252 most recently updated may have the highest update priority, the map data F 1258 least recently updated may have the lowest update priority, and the map data B 1254 may have a higher update priority than the map data K 1256.

In this example, the map data 6 1212 and the map data I 1252 having the highest update priorities correspond to the read/write command at the time t0 1210 and 1250. As described above, at the time t0 1210 and 1250, after the read/write operation is performed for the data 6 and the data I, the update operation for the map data 6 1212 and the map data I 1252 is performed.

Hereinafter, detailed descriptions will be made for an operation of updating the map data after performing the read/write operation in response to the read/write command for the random data and the consecutive data.

The map data 6 1212, the map data 11 1214, the map data 2 1216 and the map data 9 1218 are stored in the first sub buffer 1202 as the map data of the time t0 1210, and the map data I 1252, the map data B 1254, the map data K 1256 and the map data F 1258 are stored in the second sub buffer 1204 as the map data of the time t0 1250.

Then, according to the read/write command provided from the host 102 at a time t1 1220 and 1260 next to the time t0 1210 and 1250, the read/write operation is performed for the data 7 and the data H, and the corresponding map data 7 1222 and map data H 1262 are updated and stored in the first sub buffer 1202 and the second sub buffer 1204. At this time, in the case where each of the first sub buffer 1202 and the second sub buffer 1204 is already full of the map data, one among the map data stored in the first sub buffer 1202 and the second sub buffer 1204 at the time t0 1210 and 1250 is written to the memory block M 1292.

The controller 130 programs the map data 11 1214 and the map data K 1256, which have the lowest priorities among the map data stored in the first sub buffer 1202 and the second sub buffer 1204 at the time t0 1210 and 1250 according to the priorities of the map data, into the memory block M 1292. Also, the controller 130 updates and stores the map data 7 1222 and the map data H 1262 according to the read/write command at the time t1 1220 and 1260 in the first sub buffer 1202 and the second sub buffer 1204.

In the read/write command of the time t1 1220, the type information of the data 7 may indicate that the data 7 is the random data or the hot data, and the priority information of the data 7 may indicate that the data 7 has a lower priority than the data 6 of the time t0 1210. Moreover, the type information of the data H of the time t1 1260 may indicate that the data H is the consecutive data or the cold data, and the priority information of the data H may indicate that the data H has a higher priority than the data I of the time t0 1250.

According to the read rite command provided from the host 102 at the time t1 1220 and 1260, the map data 7 1222, map data 6 1224, map data 2 1226 and map data 9 1228 are stored in the first sub buffer 1202 as map data corresponding to the command of the time t1 1220, and the map data H 1262, map data I 1264, map data B 1266 and map data F 1268 are stored in the second sub buffer 1204 as map data corresponding to the command of the time t1 1260.

Among the map data stored in the first sub buffer 1202 of the time t1 1220, the map data 2 1226 may have the highest priority, the map data 7 1222 and the map data 9 1228 may have the lowest priority, and the map data 6 1224 may have a higher priority than the map data 7 1222. Also, among the map data stored in the second sub buffer 1204 of the time t1 1260, the map data B 1266 may have the highest priority, the map data I 1264 may have the lowest priority, and the map data H 1262 and the map data F 1268 may have a higher priority than the map data I 1264.

According to the read/write commands provided from the host 102 at the time t1 1220 and 1260 and times previous to the time t1, the read/write operation is performed for read/write data. Since map data for the read/write data are updated in correspondence to the read/write operation performed in this way, the map data stored in the first sub buffer 1202 and the second sub buffer 1204 have update priorities according to the update times.

For example, among the map data stored in the first sub buffer 1202 of the time t1 1220, the map data 7 1222 most recently updated may have the highest update priority, the map data 9 1228 least recently updated may have the lowest update priority, and the map data 6 1224 may have a higher update priority than the map data 2 1226. Also, among the map data stored in the second sub buffer 1204 of the time t1 1260, the map data H 1262 most recently updated may have the highest update priority, the map data F 1268 least recently updated may have the lowest update priority, and the map data I 1264 may have a higher update priority than the map data B 1266.

In this example, the map data 7 1222 and the map data H 1262 having the highest update priorities correspond to the read/write command at the time t1 1220 and 1260. As described above, at the time t1 1220 and 1260, after the read/write operation is performed for the data 7 and the data H, the update operation for the map data 7 1222 and the map data H 1262 is performed.

Then, according to the read/write command provided from the host 102 at a time t2 1230 and 1270 next to the time t1 1220 and 1260, the read/write operation is performed for the data 8 and the data G, and the corresponding map data 8 1232 and map data G 1272 are updated and stored in the first sub buffer 1202 and the second sub buffer 1204. At this time, in the case where each of the first sub buffer 1202 and the second sub buffer 1204 is already full of the map data, one among the map data stored in the first sub buffer 1202 and the second sub buffer 1204 of the time t1 1220 and 1260 are written to the memory block M 1292.

The controller 130 programs the map data 7 1222 and the map data 9 1228 and the map data I 1264, which have the lowest priorities among the map data stored in the first sub buffer 1202 and the second sub buffer 1204 of the time t1 1220 and 1260 according to the priorities of the map data, into the memory block M 1292. Also, the controller 130 updates and stores the map data 8 1232 and the map data G 1272 according to the read/write command of the time t2 1230 and 1270 in the first sub buffer 1202 and the second sub buffer 1204.

Since both the map data 7 1222 and the map data 9 1228 stored in the first sub buffer 1202 of the time t1 1220 have the lowest priority, the map data 9 1228 having the lowest update priority according to update priority is programmed to the memory block M 1292, and the map data 8 1232 according to the read/write command at the time t2 1230 is stored in the first sub buffer 1202.

Thus, in the case where a plurality of map data having the same lowest priority exist, map data having a lowest update priority according to the update priority of map data. That is, the least recently updated map data is programmed to the memory block M 1292 when the first sub buffer 1202 and the second sub buffer 1204 is already full of the map data during the map data update operation.

In the case where a plurality of map data having the same lowest priority exist, map data having a lowest update priority is programmed to the memory block M 1292 according to the LRU (least recently used)/MRU (most recently used) algorithm when the first sub buffer 1202 and the second sub buffer 1204 are already full of the map data during the map data update operation.

At this time, as described above, since map data are updated and stored in the buffer 1200 according to the priority information included in the read/write command, map data for the read/write data with a higher probability for a read/write request from the host 102 to occur (e.g., data with a higher priority) is stored in the buffer 1200. Accordingly, because an operation for recovering map data for data with a higher priority from the memory device 150 to the buffer 1200 may be omitted, a read/write operation latency may be shortened, and read/write operation performance may be improved.

In the embodiment, as described above, when updating map data corresponding to the command of the time t1 1220, since the map data 11 1214 having the lowest priority is transferred to the memory device 150 according to the priority information included in the read/write command and the map data 9 1228 is stored in the first sub buffer 1202, the read/write operation for the data 9 may be performed without the need of performing the operation for recovering the map data 9 1228 from the memory device 150.

In the read/write command of the time t2 1230, the type information of the data 8 may indicate that the data 8 is the random data or the hot data, and the priority information of the data 8 may indicate that the data 8 has a lower priority than the data 7 of the time t1 1220. Moreover, the type information of the data G of the time t2 1270 may indicate that the data G is the consecutive data or the cold data, and the priority information of the data G may indicate that the data G has a higher priority than the data H of the time t1 1260.

According to the read/write command provided from the host 102 at the time t2 1230 and 1270, the map data 8 1232, map data 7 1234, map data 6 1236 and map data 2 1238 are stored in the first sub buffer 1202 as map data corresponding to the command of the time t2 1230. The map data G 1272, map data H 1274, map data B 1276 and map data F 1278 are stored in the second sub buffer 1204 as map data corresponding to the command of the time t2 1270.

Among the map data stored in the first sub buffer 1202 of the time t2 1230, the map data 2 1238 may have the highest priority, the map data 8 1232 may have the lowest priority, and the map data 6 1236 may have a higher priority than the map data 7 1234. Also, among the map data stored in the second sub buffer 1204 of the time t2 1270, the map data B 1276 may have the highest priority, the map data H 1274 and the map data F 1278 may have the lowest priority, and the map data G 1272 may have a higher priority than the map data H 1274.

According to the read/write commands provided from the host 102 at the time t2 1230 and 1270 and times previous to the time t2 the read/write operation is performed for the read/write data. Since map data for the read/write data are updated in correspondence to the read/write operation performed in this way, the map data stored in the first sub buffer 1202 and the second sub buffer 1204 have update priorities according to the update times.

Among the map data stored in the first sub buffer 1202 of the time t2 1230, the map data 8 1232 most recently updated may have the highest update priority, the map data 2 1238 least recently updated may have the lowest update priority, and the map data 7 1234 may have a higher update priority than the map data 6 1236. Also, among the map data stored in the second sub buffer 1204 of the time t2 1270, the map data G 1272 most recently updated may have the highest update priority, the map data F 1278 least recently updated may have the lowest update priority, and the map data H 1274 may have a higher update priority than the map data B 1276.

In this example, the map data 8 1232 and the map data G 1272 having the highest update priorities correspond to, the read/write command at the time t2 1230 and 1270. As described above, at the time t2 1230 and 1270, after the read/write operation is performed for the data 8 and the data G, the update operation for the map data 8 1232 and the map data G 1272 is performed.

Then, according to the read/write command provided from the host 102 at a time t3 1240 and 1280 next to the time t2 1230 and 1270, the read/write operation is performed for the data 3 and the data C, and the corresponding map data 3 1242 and map data C 1282 are updated and stored in the first sub buffer 1202 and the second sub buffer 1204. At this time, in the case where each of the first sub buffer 1202 and the second sub buffer 1204 is already full of the map data, one among the map data stored in the first sub buffer 1202 and the second sub buffer 1204 of the time t2 1230 and 1270 are written to the memory block M 1292.

The controller 130 programs the map data 8 1232, the map data H 1274 and the map data F 1278, which have the lowest priorities among the map data stored in the first sub buffer 1202 and the second sub buffer 1204 of the time t2 1230 and 1270 according to the priorities of the map data, into the memory block M 1292. Also, the controller 130 updates and stores the map data 3 1242 and the map data C 1282 according to the read/write command of the time t3 1240 and 1280 in the first sub buffer 1202 and the second sub buffer 1204.

Since both the map data H 1274 and the map data F 1278 stored in the second sub buffer 1204 of the time t2 1270 have the lowest priority, the map data F 1278 having the lowest update priority according to update priority is programmed to the memory block M 1292, and the map data 3 1242 according to the read/write command at the time t3 1240 is stored in the first sub buffer 1202.

As described above, in the case where a plurality of map data having the same lowest priority exist, map data having a lowest update priority is programmed to the memory block M 1292 according to the LRU (least recently used)/MRU (most recently used) algorithm when the first sub buffer 1202 and the second sub buffer 1204 are already full of the map data during the map data update operation.

At this time, as described above, since map data are updated and stored in the buffer 1200 according to the priority information included in the read/write command, map data for the read/write data with a higher probability for a read/write request from the host 102 to occur (e.g., data with a higher priority) is stored in the buffer 1200. Accordingly, because an operation for recovering map data for data with a higher priority, from the memory device 150 to the buffer 1200, may be omitted, a read/write operation latency may be shortened, and read/write operation performance may be improved.

In the read/write command at the time t3 1240, the type information of the data 3 may indicate that the data 3 is the random data or the hot data, and the priority information of the data 3 may indicate that the data 3 has a higher priority than the data 8 at the time t2 1230. Moreover, the type information of the data C of the time t3 1280 may indicate that the data C is the consecutive data or the cold data, and the priority information of the data C may indicate that the data C has a higher priority than the data G of the time t2 1270.

According to the read/write command provided from the host 102 at the time t3 1240 and 1280, the map data 3 1242, map data 7 1244, map data 6 1246 and map data 2 1248 are stored in the first sub buffer 1202 as map data corresponding to the command of the time t3 1240, and the map data C 1282, map data G 1284, map data H 1286 and map data B 1288 are stored in the second sub buffer 1204 as map data corresponding to the command of the time t3 1280.

Among the map data stored in the first sub buffer 1202 of the time t3 1240, the map data 2 1248 may have the highest priority, the map data 7 1244 may have the lowest priority, and the map data 3 1242 and the map data 6 1246 may have a higher priority than the map data 7 1244. Also, among the map data stored in the second sub buffer 1204 of the time t3 1280, the map data C 1282 and the map data B 1288 may have the highest priority, the map data H 1286 may have the lowest priority, and the map data G 1284 may have a higher priority than the map data H 1286.

According to the read/write commands provided from the host 102 at the time t3 1240 and 1280 and times previous to the time t3, the read/write operation is performed for the read/write data. Since map data for the read/write data are updated in correspondence to the read/write operation performed in this way the map data stored in the first sub buffer 1202 and the second sub buffer 1204 have update priorities according to the update times.

Among the map data stored in the first sub buffer 1202 of the time t3 1240, the map data 3 1242 most recently updated may have the highest update priority, the map data 2 1248 least recently updated may have the lowest update priority, and the map data 7 1244 may have a higher update priority than the map data 6 1246. Also, among the map data stored in the second sub buffer 1204 of the time t3 1280, the map data C 1282 most recently updated may have the highest update priority, the map data B 1288 least recently updated may have the lowest update priority, and the map data G 1284 may have a higher update priority than the map data H 1286.

In this example, the map data 3 1242 and the map data C 1282 having the highest update priorities correspond to the read/write command at the time t3 1240 and 1280. As described above, at the time t3 1240 and 1280, after the reed/write operation is performed for the data 3 and the data C, the update operation for the map data 3 1242 and the map data C 1282 is performed.

In this way, in the embodiment, read write for read/write data provided from the host 102 is performed, update of map data in correspondence to the read/write data is performed and map data are stored in the buffer 1200. Map data are updated and stored in the corresponding sub buffers 1202 and 1204 of the buffer 1200 according to the type information included in the read/write command. In the case where the buffer 1200 is already full of the map data, map data having a lowest priority is programmed to the memory device 150 according to the priority information included in the read/write command. In the case where a plurality of map data have the same lowest priority, the least recently updated map data according to update priority of the LRU/MRU algorithm, is programmed to the memory device 150.

FIG. 13 is a flow chart illustrating the data processing operation of the memory system 110 in accordance with an embodiment.

Referring to FIG. 13, a memory system 110 receives a read/write command from a host at step 1310, and identifies the read/write command provided from the host, at step 1320. The type information and the priority information of the read/write data are included in the read/write command. Since detailed descriptions were made above for the type information and the priority information of read/write data, further descriptions thereof will be omitted herein.

At step 1330, a read/write operation for the read/write data provided from the host is performed. Namely, read data are read from a memory device 150 and are provided to the host, and write data are written and stored in the memory device 150.

Then, at step 1340, in correspondence to the read/write operation, map data for the read/write data are updated.

Since detailed descriptions were made above with reference to FIG. 12 for the read/write operation for the read/write data provided from the host and an update operation for the map data, that is, the data processing operations in the embodiment, further descriptions thereof will be omitted herein.

The memory system and the operating method thereof according to the embodiments may minimize its complexity and performance deterioration, and thereby quickly and efficiently process data to and from a memory device.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device including a plurality of memory blocks; and
a controller suitable for performing read and write operations respectively in response to read and write commands, and update map data, which is stored in a buffer, as a result of the operations according to priority information of data stored in the memory blocks.

2. The memory system according to claim wherein the priority information is included in each of the commands.

3. The memory system according to claim 1, wherein the priority information represents priorities between first and second data corresponding to the command provided at different times.

4. The memory system according to claim 3,
wherein the priorities between the first data and the second data are determined according to data importance or data processability between the first data and the second data,
wherein the data importance is determined according to kinds of the first data and the second data, and
wherein the data processability is determined according to processing counts, required processing speeds and data sizes of the first data and the second data.

5. The memory system according to claim 1, wherein, in the case where the buffer is full of the map data, the controller programs one of the map data having a lowest priority into the memory blocks according to the priority information.

6. The memory system according to claim 5, wherein, in the case where two or more of the map data have the same lowest priority, the controller programs one of the two or more map data having a lowest update priority into the memory blocks according to update priorities of the map data.

7. The memory system according to claim 5, wherein the lowest update priority is determined according to an LRU (least recently used)/MRU (most recently used) algorithm.

8. The memory system according to claim 1,
wherein the controller stores the map data in different sub buffers in the buffer according to type information of the data, and
wherein the type information is determined according to locality of the data and a frequency/count of the operations.

9. The memory system according to claim 8, wherein the type information of the data is included in each of the commands, or is identified from a pattern of each of the commands.

10. The memory system according to claim 8, wherein the controller stores map data for random data or hot data in a first sub buffer, and stores map data for consecutive data or cold data in a second sub buffer according to the type information.

11. A method for operating a memory system including a plurality of memory blocks, comprising:
identifying a command provided from a host;
performing an operation in response to the command; and
updating map data, which is stored in a buffer, as a result of the operation according to priority information of data stored in the memory blocks.

12. The method according to claim 11, wherein the priority information is included in the command.

13. The method according to claim 11, wherein the priority information represents priorities between first and second data corresponding to a command provided at different time.

14. The method according to claim 13,
wherein the priorities between the first data and the second data are determined according to data importance or data processability between the first data and the second data,
wherein the data importance is determined according to kinds of the first data and the second data, and
wherein the data processability is determined according to processing counts or required processing speeds of the first data and the second data.

15. The method according to claim 11, wherein, in the case where the buffer is full of the map data, the updating of the map data programs one of the map data having a lowest priority into the memory blocks according to the priority information.

16. The method according to claim 15, wherein, in the case where two or more of the map data have the same lowest priority, the updating of the nap data programs one of the two or more map data having a lowest update priority into the memory blocks according to update priorities of the map data.

17. The method according to claim 15, wherein, the lowest update priority is determined according to an LRU (least recently used)/MRU (most recently used) algorithm.

18. The method according to claim 11,
wherein in the updating, the map data are stored in different sub buffers in the buffer according to type information of the data, and
wherein the type information is determined according to locality of the data and a frequency/count of the operation.

19. The method according to claim 18, wherein the type information of the data is included in the command, or is identified from a pattern of the command.

20. The method according to claim 18, wherein, in the updating, map data for random data or hot data is stored in a first sub buffer and map data for consecutive data or cold data is stored in a second sub buffer, according to the type information.
